(19) United States
(12) Patent Application Publication
(10) Pub. No.: US 2010/0324705 A1
(43) Pub. Date: Dec. 23, 2010

(54) CONTROLLER FOR IPOD SHUFFLE

(76) Inventor: Jesse Vandiver, Oxnard, CA (US)

Correspondence Address: Arent Fox LLP, 555 West Fifth Street, 48th Floor, Los Angeles, CA, 90013, US

(21) Appl. No.: 12/486,614

(22) Filed: Jun. 17, 2009

(51) Int. Cl. G06F 17/00

(52) U.S. Cl. 700/94

(57) ABSTRACT

A controller for a digital audio player is provided. The controller for the digital audio player includes a body. A jack plug extends from the body. A jack socket is within the body and is coupled to the jack plug. A plurality of buttons is on the body and is coupled to the jack plug.

### BACKGROUND

1. Field

The present disclosure relates to a controller and, more particularly, to a controller for the iPod shuffle.

2. Description of Related Art

The iPod shuffle® (registered trademark of Apple Inc.) is a digital audio player without volume or track controls on the device itself. The iPod shuffle includes a 3.5 mm four-conductor (i.e., four contact) female TRRS (tip, ring, ring, sleeve) connector (also known as a four-conductor jack socket) to which dedicated Apple headphones with a 3.5 mm four-conductor male TRRS connector (also known as a four-conductor jack plug) can connect. The dedicated Apple headphones provide volume and track controls for controlling the iPod shuffle.

If a user would like to use headphones other than the dedicated Apple headphones, the user loses the ability to control the volume and the track played by the iPod shuffle. As such, there is a need for a device that allows a user to use headphones other than the dedicated Apple headphones while providing volume and track control for the iPod shuffle. Furthermore, there is a need for a device that protects the iPod shuffle while still providing volume and track control.

### SUMMARY

In one aspect of the disclosure, a controller for a digital audio player includes a body. A jack plug extends from the body. A jack socket is within the body and is coupled to the jack plug. A plurality of buttons is on the body and is coupled to the jack plug.

In another aspect of the disclosure, a controller for a digital audio player includes a body. A jack plug extends from the body and is configured to couple to a jack socket of the digital audio player. A jack socket is within the body and is coupled to the jack plug. The jack socket is configured to provide audio output from the digital audio player. A plurality of buttons is coupled to the jack plug. The plurality of buttons is configured to control the digital audio player.

It is understood that other aspects of a controller for an iPod shuffle will become readily apparent to those skilled in the art from the following detailed description, wherein it is shown and described only exemplary configurations of a controller for an iPod shuffle. As will be realized, the invention includes other and different aspects of a controller for an iPod shuffle and the various details presented throughout this disclosure are capable of modification in various other respects, all without departing from the spirit and scope of the invention. Accordingly, the drawings and the detailed description are to be regarded as illustrative in nature and not as restrictive.

### BRIEF DESCRIPTION OF THE DRAWINGS

FIG, 1 is a perspective view of a first example of a controller for an iPod shuffle.

FIG. 2 is a front view of the controller of FIG. 1.

FIG. 3 is a side view of the controller of FIG. 1.

FIG. 4 is a rear view of the controller of FIG. 1.

FIG. 5 is a top view of the controller of FIG. 1.

FIG. 6 is a bottom view of the controller of FIG. 1.

FIG. 7 is a perspective view of the controller of FIG. 1 with an attached iPod shuffle.

FIG. 8 is a perspective view of a second example of a controller for an iPod shuffle.

FIG. 9 is a front view of the controller of FIG. 8.

FIG. 10 is a side view of the controller of FIG. 8.

FIG. 11 is a rear view of the controller of FIG. 8.

FIG. 12 is a top view of the controller of FIG. 8.

FIG. 13 is a bottom view of the controller of FIG. 8.

FIG. 14 is a perspective view of the controller of FIG. 8 with an attached iPod shuffle.

FIG. 15 is a rear view of a third example of a controller.

FIG. 16 is a block diagram showing the control interconnectivity of the controllers and an iPod shuffle.

FIG. 17 is a circuit diagram showing the interconnectivity of the buttons and the integrated circuit.

### DETAILED DESCRIPTION

The present invention is described more fully hereinafter with reference to the accompanying drawings, in which various aspects of a controller for an iPod shuffle are shown. This invention, however, may be embodied in many different forms and should not be construed as limited by the various aspects of the controller presented herein. The detailed description of the controller is provided below so that this disclosure will be thorough and complete, and will fully convey the scope of the present invention to those skilled in the art.

The detailed description may include specific details for illustrating various aspects of a controller for an iPod shuffle. However, it will be apparent to those skilled in the art that the invention may be practiced without these specific details. In some instances, well known elements may be shown in block diagram form, or omitted, to avoid obscuring the inventive concepts presented throughout this disclosure.

Various aspects of a controller for an ipod shuffle may be illustrated with reference to one or more exemplary embodiments. As used herein, the term “exemplary” means “serving as an example, instance, or illustration,” and should not necessarily be construed as preferred or advantageous over other embodiments of the controller disclosed herein. In addition, the term “coupled” means that two elements are connected either directly or indirectly with one or more intervening elements.

FIG. 1 is a perspective view of a controller 10 for an iPod shuffle. The controller 10 includes a jack plug 11 for inserting into the jack socket of the iPod shuffle; a jack socket 13; buttons 14, 15, and 16; and a body 12. The jack plug 11 may be a 3.5 mm four-conductor male TRRS connector. Accordingly, the jack plug 11 may include four contacts: 11L (left headphone), 11R (right headphone), 11G (ground), and 11D (data line). The jack plug 11 extends from the body 12. The jack socket 13 is coupled to jack plug 11 and extends within the body 12. The jack socket 13 may be a 3.5 mm three-conductor female TRS connector. Accordingly, the jack socket 13 may provide a connection for a standard jack plug so that a user can use standard, third-party headphones. The jack socket 13 is coupled to three of the four contacts 11L, 11R, and 11G of the jack plug 11. The buttons 14, 15, 16 are coupled to the other of the four contacts 11D of the jack plug 11 and provide volume and track control for an attached iPod shuffle. Specifically, the male tip, the first male ring, and the second male ring of the jack plug 11 are coupled to the female tip, the female ring, and the female sleeve, respectively, of the jack socket 13; and the buttons 14, 15, 16 are coupled to the male sleeve of the jack plug 11. The buttons 14, 15, 16 may correspond to the buttons on the dedicated Apple headphones. Accordingly, the button 14 provides volume up control for increasing a volume of the audio signal output by the jack plug 11; the button 16 provides volume down control for decreasing the volume of the audio signal output by the jack plug 11; and the button 15 provides track control of the audio signal output by the jack plug 11, with a single click providing a play/pause command, a double click providing a go to next track command, and a triple click providing a go to previous track command.

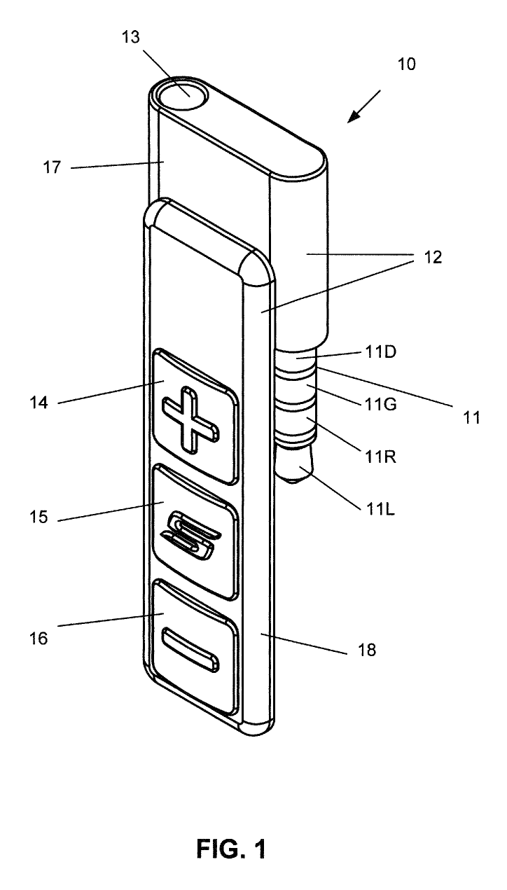

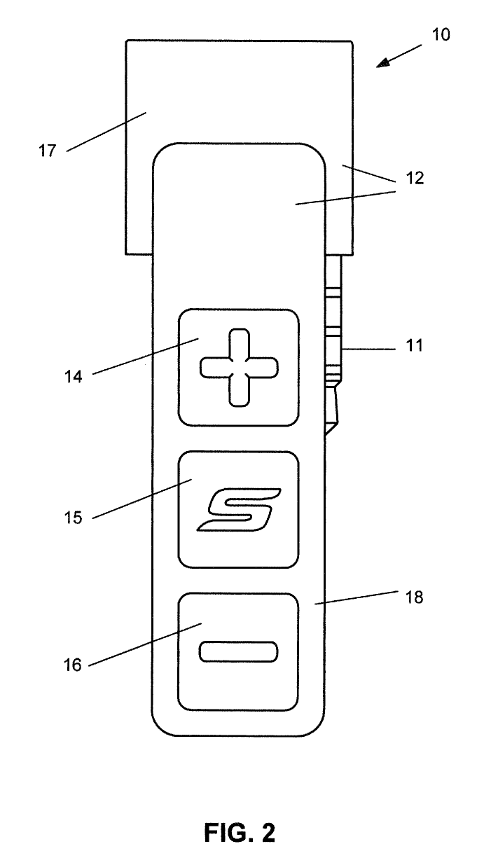

FIG. 2 is a front view of the controller 10. As shown in FIG. 2, the body 12 includes a first body portion 17 and a second body portion 18. The first body portion 17 may extend flush with an attached iPod shuffle and the second body portion 18 may extend out from the first body portion 17 and extend to cover a front of the iPod shuffle. The second body portion 18 protects a front side of an attached iPod shuffle. The jack plug 11 extends from the first body portion 17 and the jack socket 13 is within the first body portion 17. The buttons 14, 15, 16 are located on the second body portion 18.

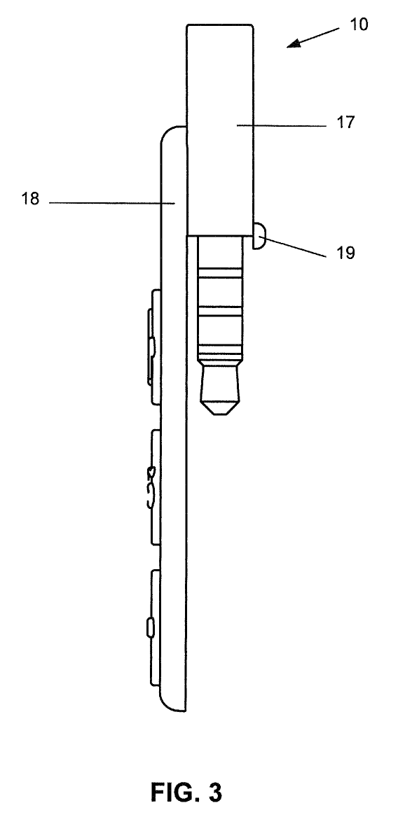

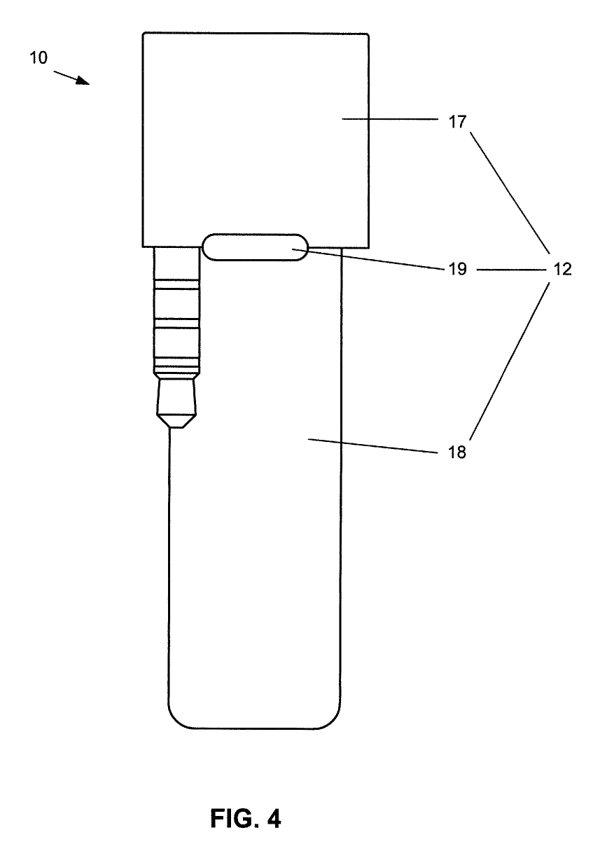

FIG. 3 is a side view of the controller 10. FIG. 4 is a rear view of the controller 10. As shown in FIG. 3 and FIG. 4, the body 12 includes a rear alignment tab 19. The rear alignment tab 19 fits over a backside of an iPod shuffle to align the iPod shuffle and to allow the iPod shuffle to be attached more securely. The rear alignment tab 19 also helps prevent damage to the jack plug 11 by preventing an attached iPod shuffle from being rotated away from the second body portion 18 while still connected to jack plug 11.

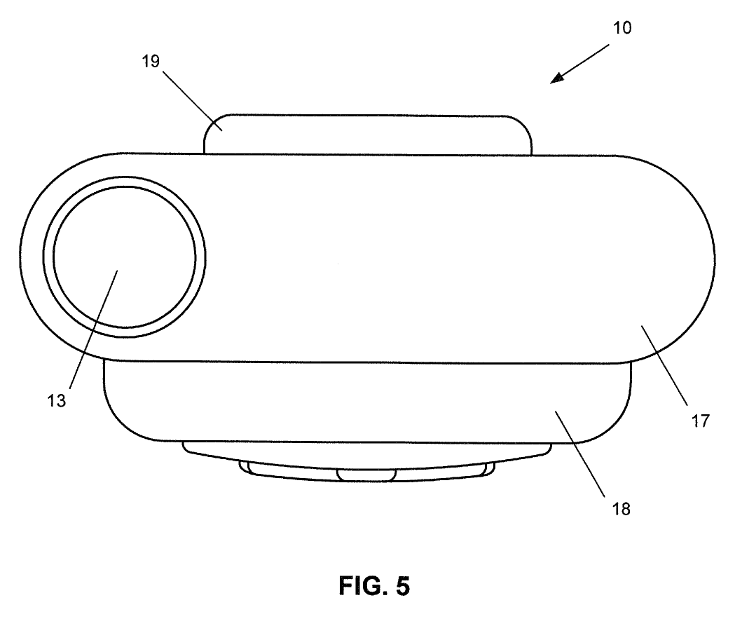

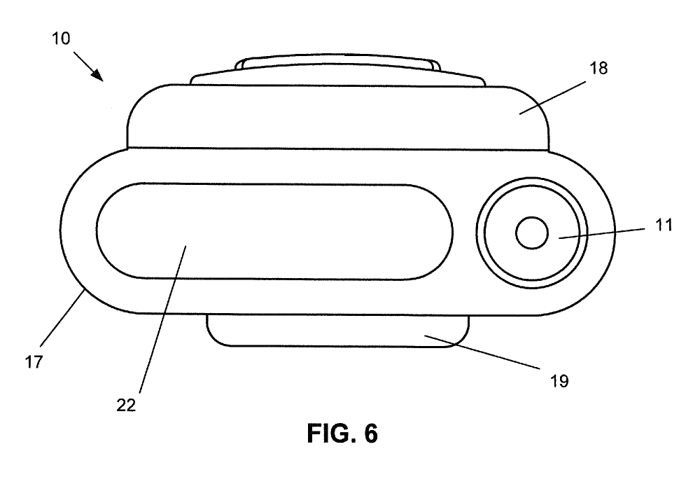

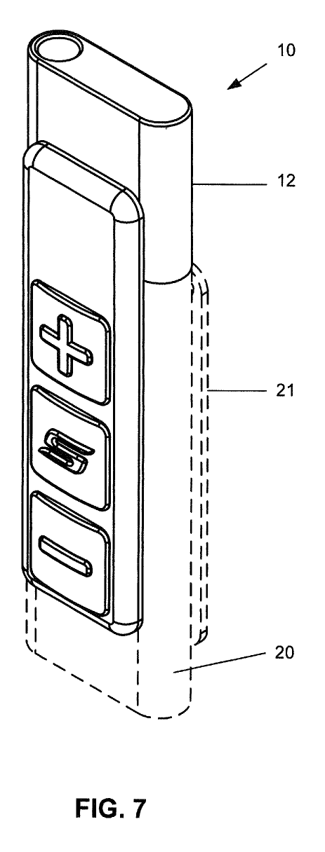

FIG. 5 is a top view of the controller 10. FIG. 6 is a bottom view of the controller 10. FIG. 7 is a perspective view of the controller 10 with an attached iPod shuffle 20. As shown in FIG. 6, the first body portion 17 includes a clearance pocket 22 for the on/off switch on the ipod shuffle. The clearance pocket 22 provides clearance space for the on/off switch, which extends above the iPod shuffle. As shown in FIG. 7, an iPod shuffle 20 may be attached to the controller 10. The body 12 extends flush with and extends down a front side of the iPod shuffle 20. A spring clip 21 is attached to the iPod shuffle 20, which allows a user to clip the iPod shuffle 20 and the attached controller 10 to another article, such as clothing.

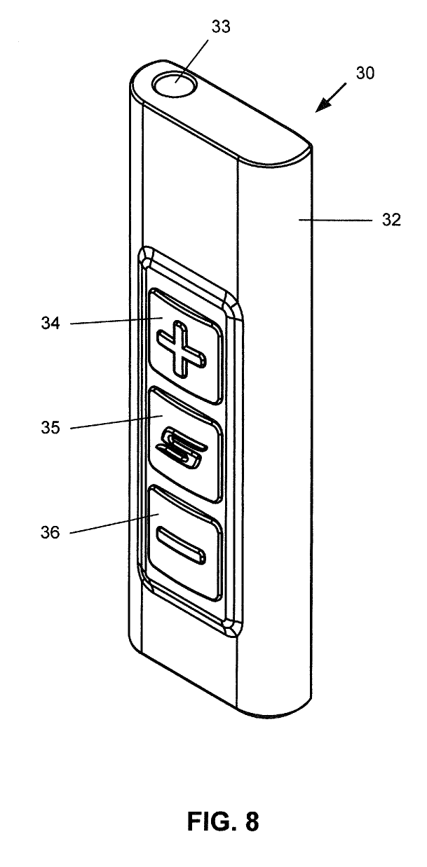

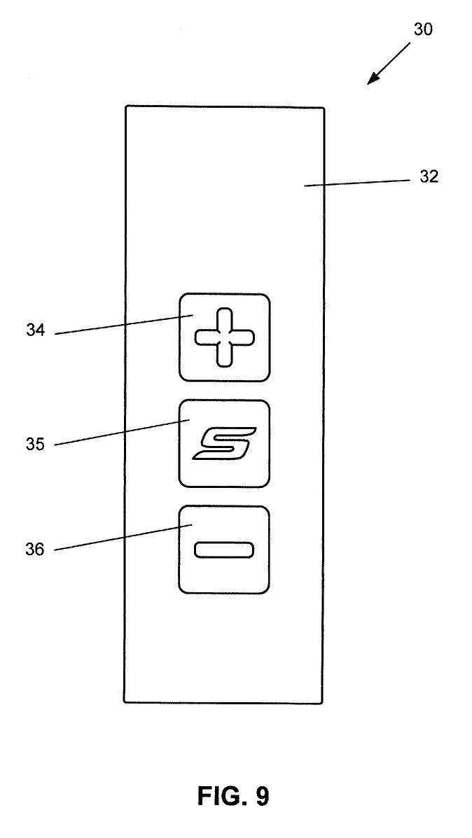

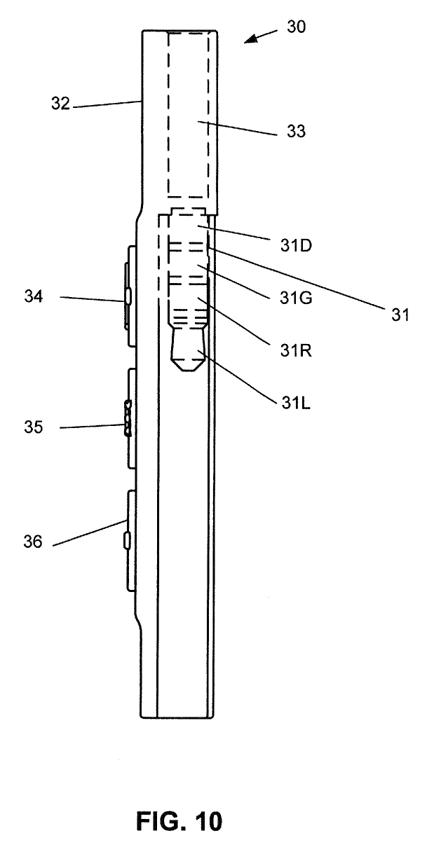

FIG. 8, FIG. 9, and FIG. 10 are perspective, front, and side views of a controller 30 for an iPod shuffle. The controller 30 includes a jack plug 31 for inserting into the jack socket of the iPod shuffle; a jack socket 33; buttons 34, 35, and 36; and a case 32. The jack plug 31 may be a 3.5 mm four-conductor male TRRS connector. Accordingly, the jack plug 31 may include four contacts: 31L (left headphone), 31R (right headphone), 31G (ground), and 31D (data line). The jack plug 31 extends from the case 32. The jack socket 33 is coupled to jack plug 31 and extends within the case 32. The jack socket 33 may be a 3.5 mm three-conductor female TRS connector. Accordingly, the jack socket 33 may provide a connection for a standard jack plug so that a user can use standard, third-party headphones. The jack socket 33 is coupled to three of the four contacts 31L, 31R, and 31G of the jack plug 31. The buttons 34,35, 36 are coupled to the other of the four contacts 31D of the jack plug 31 and provide volume and track control for an attached iPod shuffle. The buttons 14, 15, 16 may correspond to the buttons on the dedicated Apple headphones. Accordingly, the button 14 provides volume up control; the button 16 provides volume down control; and the button 15 provides track control, with a single click providing a play/pause command, a double click providing a go to next track command, and a triple click providing a go to previous track command.

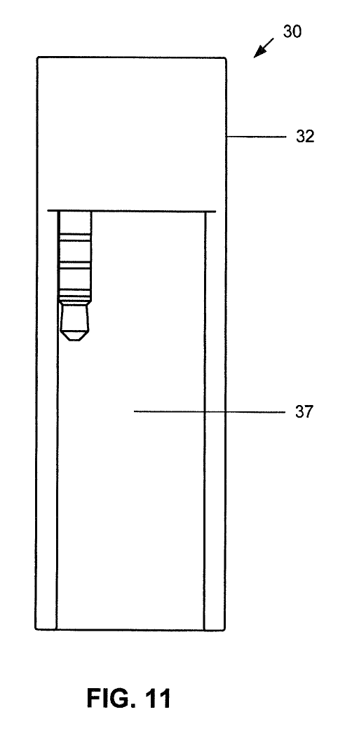

FIG. 11 is a rear view of the controller 30. As shown in FIG. 11, the case 32 provides a partial enclosure 37 for partially enclosing an attached iPod shuffle. The partial enclosure 37 provides additional protection for the iPod shuffle in case the iPod shuffle and the controller 30 are dropped. The partial enclosure 37 may provide an opening on a backside to allow the spring clip of the iPod shuffle to extend outside the case 32 so that a user can use the spring clip.

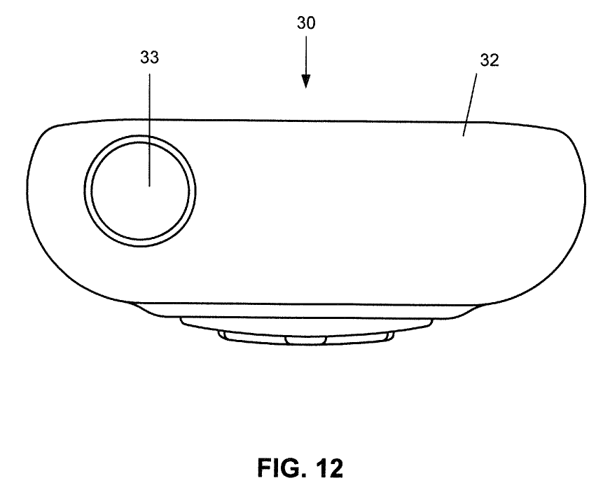

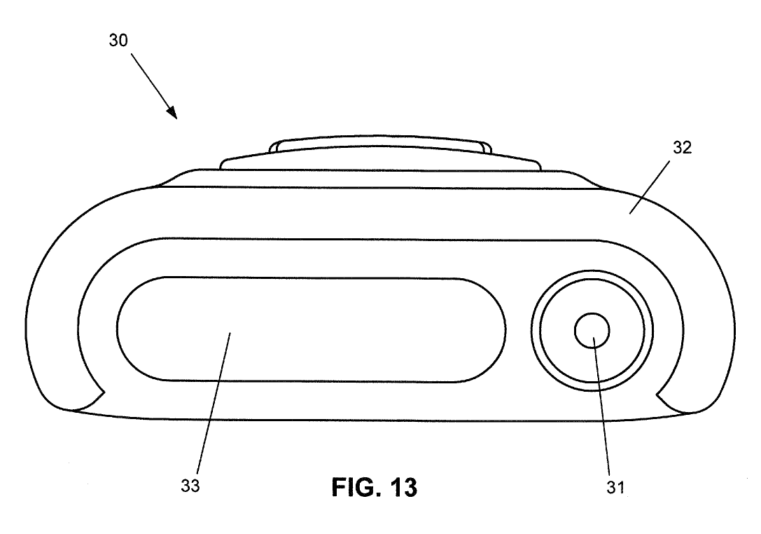

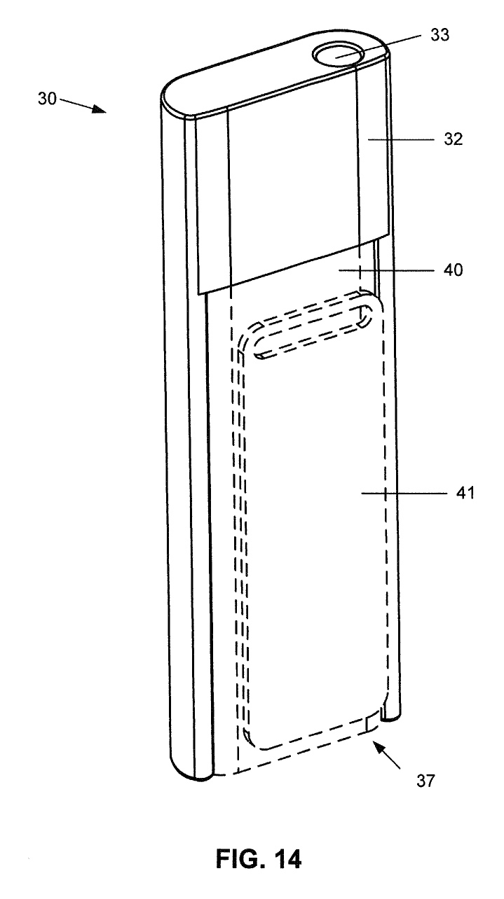

FIG. 12 is a top view of the controller 30. FIG. 13 is a bottom view of the controller 30. FIG. 14 is a perspective view of the controller 30 with an attached iPod shuffle 40. As shown in FIG. 13, the case 32 includes a clearance pocket 38 for the on/off switch on the iPod shuffle. The clearance pocket 38 provides clearance space for the on/off switch, which extends above the iPod shuffle. As shown in FIG. 14, an iPod shuffle 40 is insertable into the partial enclosure 37 of the case 32. The partial enclosure 37 provides an opening to allow the spring clip 41 to extend out the opening so that a user can use the spring clip 41.

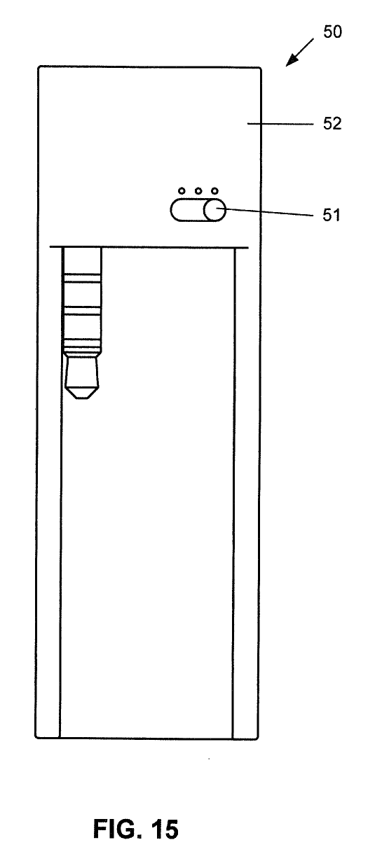

FIG. 15 is a rear view of a controller 50. As shown in FIG. 15, the controller 50 includes a switch 51 for interfacing with a switch on the iPod shuffle. The iPod shuffle provides a switch on a top side of the device for turning the device on and off. The “on” position has two settings: random play and in-order play. Accordingly, the switch 51 may provide three positions: a random setting, an in-order setting, and an off setting. In one configuration, the switch 51 is coupled to an “L” shaped connector and the “L” shaped connector is coupled to the switch of the iPod shuffle through a connector formed to fit over the switch of the iPod shuffle. The “L” shaped connector may be aligned with the switch 51 and the switch of the iPod shuffle with an internal bracket. The controller 50 may include a case 52 that completely encloses an attached iPod shuffle so as to fully protect the iPod shuffle from being damaged. The case 52 may have its own clip, as the spring clip of the iPod shuffle may be fully enclosed within the case 52 or may be removable from the ipod shuffle.

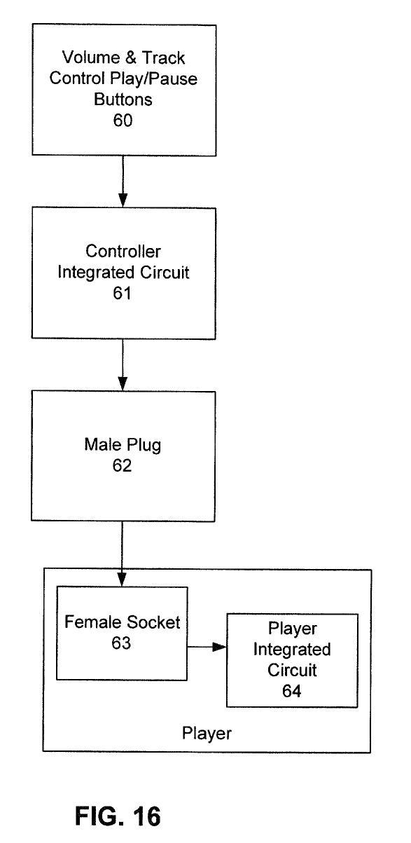

FIG. 16 is a block diagram showing the control interconnectivity of the controllers 10, 30, 50 and an iPod shuffle. Each of the controllers 10, 30, 50 includes a controller integrated circuit 61 that receives input from the volume and track control play/pause buttons 60. The controller integrated circuit 61 receives the input, formulates an input for the player integrated circuit 64 of a digital audio player (which may be an iPod shuffle), and provides the formulated input to the player integrated circuit 64 through male plug 62 and female socket 63. The volume and track control play/pause buttons 60 correspond to buttons 14, 15, 16 of the controller 10 and buttons 34, 34, 36 of controller 30. The male plug 62 corresponds to the jack plug 11 of the controller 10 and to jack plug 31 of the controller 30.

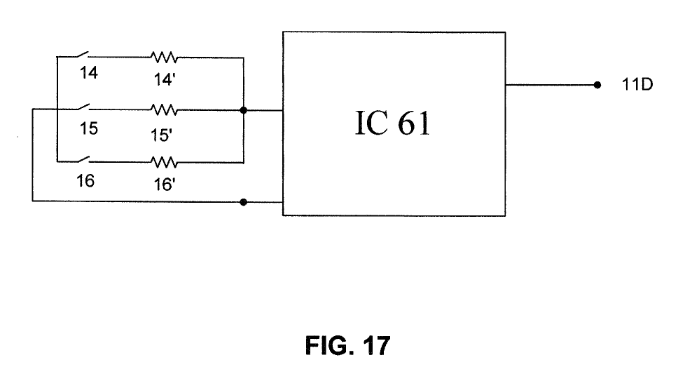

FIG. 17 is a circuit diagram showing the interconnectivity of the buttons 14, 15, 16 and the integrated circuit 61. The integrated circuit 61 may be a Texas Instrument <model>. The integrated circuit 61 provides at least two input pins and one output pin. The output pin is coupled to 11D and 31D of the jack plug 11 and 31, respectively. One of the input pins provides a voltage and is coupled to the buttons 14, 15, 16, which may be momentary single-pole single-throw switches. The switches 14, 15, 16 are coupled to the resistors 14′, 15′, 16′, respectively, and the resistors are coupled to the other of the input pins of the integrated circuit 61. In another configuration, only two of the resistors 14′, 15′, 16′ are in the circuit. As such, in the alternate configuration, one of the switches may be coupled directly between the two pins, with the other of the two switches connected in series with a resistor and together with the series resistor coupled in parallel between the two input pins.

The various aspects of this disclosure are provided to enable one of ordinary skill in the art to practice the present invention. Modifications to various aspects of a controller for an iPod shuffle presented throughout this disclosure will be readily apparent to those skilled in the art, and the concepts disclosed herein may be extended to other applications to interface with other digital audio players. Thus, the claims are not intended to be limited to the various aspects of the controller presented throughout this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A controller for a digital audio player, comprising:
a body;
a jack plug extending from the body;
a jack socket within the body and coupled to the jack plug; and
a plurality of buttons on the body and coupled to the jack plug.

2. The controller of claim 1, wherein the body is configured to at least partially protect the digital audio player.

3. The controller of claim 1, wherein the jack plug comprises a male tip, a male first ring, a male second ring, and a male sleeve and the jack socket comprises a female tip, a female ring, and a female sleeve; the male tip is coupled to the female tip; the male first ring is coupled to the female ring; the male second ring is coupled to the female sleeve; and the plurality of buttons are coupled to the male sleeve.

4. The controller of claim 1, wherein the plurality of buttons comprise a first button configured to provide a volume up command to the digital audio player, a second button configured to provide a volume down command to the digital audio player, and a third button configured to provide track control commands to the digital audio player.

5. The controller of claim 4, wherein the third button controls an audio signal output by the jack socket, the first button increases a volume of the audio signal output by the jack socket, and the second button decreases the volume of the audio signal output by the jack socket.

6. The controller of claim 4, further comprising a circuit housed within the body, wherein the circuit receives the volume up command, the volume down command, and the track control commands, and outputs a corresponding command to the jack plug, wherein the jack plug receives an audio signal from the digital audio player and provides the audio signal to the jack socket.

7. A controller for a digital audio player, comprising:
a body;
a jack plug extending from the body and configured to couple to a jack socket of the digital audio player;
a jack socket within the body configured to provide audio output from the digital audio player; and
a plurality of buttons configured to control the digital audio player.

8. The controller of claim 7, wherein the jack plug is a 3.5 mm four-conductor male TRRS connector.

9. The controller of claim 7, wherein the jack socket is a 3.5 mm three-conductor female TRS connector.

10. The controller of claim 7, wherein the jack plug comprises a tip, a first ring, a second ring, and a sleeve; the jack socket is coupled to the tip, the first ring, and the second ring; and the plurality of buttons are coupled to the sleeve.

11. The controller of claim 7, wherein the plurality of buttons comprise a first button configured to provide a volume up command to the digital audio player, a second button configured to provide a volume down command to the digital audio player, and a third button configured to provide track control commands to the digital audio player.

12. The controller of claim 7, further comprising an integrated circuit housed within the body and coupled to the plurality of buttons and to the jack plug, wherein the integrated circuit is configured to receive input from the plurality of buttons, to process the input to formulate an input to the digital audio player, and to provide the formulated input to the digital audio player.

13. The controller of claim 7, wherein the digital audio player is an iPod shuffle.

14. The controller of claim 7, wherein:
the body comprises a first body portion and a second body portion,
the first body portion is configured to extend from a top side of the digital audio player and the second body portion is configured to extend down a front side of the digital audio player to protect the front side of the digital audio player,
the jack plug extends from the first body portion to connect with the jack socket of the digital audio player,
the jack socket is within the first body portion, and
the plurality of buttons are on the second body portion.

15. The controller of claim 14, wherein the body further comprises a rear alignment tab extending from the first body portion in parallel with the second body portion, the rear alignment tab being configured to align the digital audio player between the rear alignment tab and the second body portion.

16. The controller of claim 14, wherein the first body portion comprises a clearance pocket located adjacent the jack plug, the clearance pocket being configured to provide clearance for a mechanical switch of the digital audio player.

17. The controller of claim 7, wherein the body comprises a case configured to at least partially enclose the digital audio player.

18. The controller of claim 17, wherein the case comprises an opening configured to allow insertion of the digital audio player and access to a clip attached to the digital audio player.

19. The controller of claim 17, wherein the case is configured to completely enclose the digital audio player.

20. The controller of claim 17, wherein the controller further comprises a mechanical switch on the case, the mechanical switch being configured to couple to a mechanical switch of the digital audio player.
